(19) United States
(12) Patent Application Publication
(10) Pub. No.: US 2005/0003869 A1
(43) Pub. Date: Jan. 6, 2005

(54) Arrangement for creating user detected vibration with low mass actuator

(75) Inventor: Terho Kaikuranta, Piispanristi (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/611,357

(22) Filed: Jun. 30, 2003

(51) Int. Cl. H04M 1/00; H04B 1/38

(52) U.S. Cl. 455/567

(57) ABSTRACT

An arrangement is provided for creating a user detected vibration with a low mass actuator featuring a product cover and a low mass actuator. The product cover has two parts coupled by an elastic joint. The low mass actuator is coupled between the two parts, and responds to an actuation signal, for vibrating the two parts of the product cover in relation to one another. The elastic joint may be made from an adhesive layer. The low mass actuator may be a linear actuator. The arrangement may be a mobile phone. The actuation motor moves the two parts of the product cover a distance in a range of about 5-15 microns. The arrangement further comprises a battery for powering the actuation motor. The arrangement may include many different small products, including a wrist phone, amulet/pendulum/pen-phones, or small standard phones or accessories.

### BACKGROUND OF THE INVENTION

1. Field Of Invention

This invention relates to an arrangement for providing haptic user feedback (vibration based actuation); and more particularly to a technique for creating user detected vibration with low mass actuator, including vibrating a mobile phone or other small product for alerting the user thereof.

2. Description of Related Art

Haptic user feedback applications are known. Several problems have been addressed in the creation of applications that are preventing its use in products. One specific problem is the question of how vibration can be created in cases when products or actuator components are very small. Typical vibration motor implementation with rotating mass is not efficient when small devices and actuator motors (i.e. low mass, low momentum) are concerned.

Haptic actuators, such as a vibration alert motor, typically are based on a moving mass producing mechanical forces that produce a vibration that is transmitted through product structures, the product cover and a user's hand or other body part. An electric motor moves or rotates a mass, which is mechanically suspended in a way that produces vibration while moved (eccentric, off-center, wabbler action).

If very small products are made, typically the existing motors and weights appear too big. Known size reduction designs are based on reduction of mass size, which obviously has an effect on vibration efficiency, thus reducing the benefit of having such a feature. Another way is to use existing parts from a product as rotation counterweight mass. This might work but it introduces major problems in product design, mechanical integration and production. Also, reliability problems would arise.

In addition, there are other problems which the invention tries to overcome, including the fact that small vibration motors use small rotating mass, that therefore also have a low mass; conventional linear actuators have the same problem; due to the low mass, vibration amplitude is typically low and haptic sensation effect is minimal; and if vibration motors are buried inside phone mechanics (as typical), the effectiveness is further reduced. In view of this, no good technical solution exists in the prior art for small product implementation—feasible vibration alert/haptic product features cannot be made.

Moreover, other approaches have been tried, including: reducing motor mass size, which reduces the effect; using the existing mass from product, e.g. a battery as motor weight, which provides for a difficult implementation and manufacturing, reliability risks with parts; and bi-directionally oscillating the mass (no rotating), which mainly increases the vibration frequency.

The present invention provides a solution to the aforementioned problem in the art.

### SUMMARY OF INVENTION

In its broadest sense, the present invention provides a new and unique method and implementation to create a user detected vibration with a small and low mass actuator, especially well suited for very small products.

The innovation solves a long felt problem in the art by introducing a novel product structure which eliminated the need of having a moving mass operation. It is based on the idea of using the product's cover as vibration transmission channel without using rotating (or linearly) moving counterweights that are typical to known solutions. As required, the vibration amplitude is quite small (physiological sensitivity threshold ^{˜}1 micron (^{μ}m), clear sensation ^{˜}10 ^{μ}m, strong sensation ^{˜}100 ^{μ}m), the product can be built from two parts that are elastically joined with each other. This will compose a tightly integrated assembly of an actuation motor, elastic joint and the product's cover; therefore, there is no structures that would absorb significant residual vibration energy.

In effect, by not using the principle based on a moving mass, one can implement a product structure that is effective in delivering vibration from actuators into a user's perception. This arrangement is not dependent on actuator mass size (or weight) and it can, therefore, be effectively applied with small products, such as wrist phones, amulet/pendulum/pen-phones, or ultimately small standard phones or accessories.

The present invention also presents a generic structural arrangement and vibration creation system which is not intended to be limited to exactly how a haptic actuator component or elastic joint is arranged.

The invention improves earlier solutions, as follows: Enables use of haptic/vibration features in very small products that otherwise cannot tolerate the existing size of vibration motors; and possibly can be used in marketing, e.g. pulsating a personal device with a warm human feel.

The scope of the invention is intended to include many different haptic applications, including: 1) PC/console game controls that use haptic actuation/force feedback. 2) Special applications that use active haptic feedback: vehicle controls, surgical telemanipulators, aircraft controls (stall alert on control stick/wheel) and cars. The technology is getting small enough for many different types of handheld consumer products. 3) Very small products are especially problematic such as jewelry-type products, amulets, pendulums, wrist phones and pen phones.

### BRIEF DESCRIPTION OF THE DRAWING

The drawing, not drawn to scale, includes the following Figures:

FIG. 1 is a block diagram showing the basic principle of the invention that relates to separating a device in two halves and joining them with an elastic joint that together forms the subject matter of the present invention. One or more linear or low mass actuators may be located near the joint and are capable of creating vibration with cover halves.

FIG. 2 is an illustration of a structure used to enable vibration creation. The one or more linear or low mass actuators shown therein can create small amplitude vibration which is transmitted to cover halves.

FIGS. 3(a), (b), (c), (d), (e) and (f) show alternate ways to cut or separate the product or device cover in two halves or pieces.

### DETAILED DESCRIPTION OF INVENTION

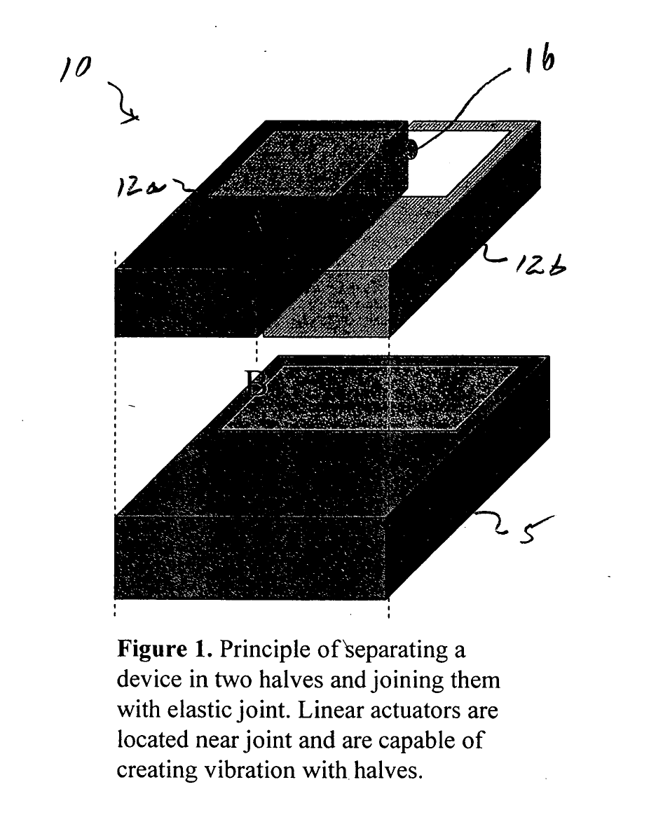

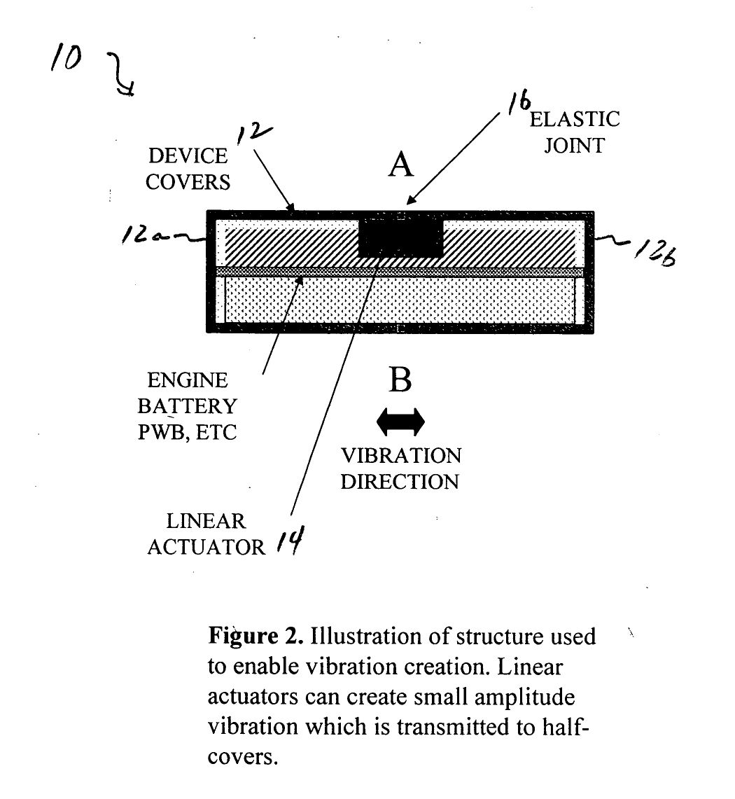

FIGS. 1 and 2 show an arrangement generally indicated as 10 for creating a user detected vibration with a low mass actuator featuring a product or device cover 12 and a low mass actuator 14. (For the sake of comparison, FIG. 1 also shows the one-piece product generally indicated as 5.) The product or device cover 12 has two parts 12a, 12b coupled by an elastic joint generally indicated as 16. The low mass actuator 14 is coupled between the two parts 12a, and responds to an actuation signal, for vibrating the two parts 12a, 12b of the product or device cover 12 in relation to one another.

The actuation signal may come from an electronic component inside the phone, or from a telecommunication signal received by the phone, etc. The scope of the invention is not intended to be limited to where the actuation signal is generated.

The elastic joint 16 may be made from an adhesive layer, as well as made from other elastomeric materials. The scope of the invention is not intended to be limited to how the elastic joint 16 couples the two parts 12a, 12b of the product or device cover 12, or the type of material used to form the elastic joint 16. Moreover, embodiments are also envisioned in which no elastic joint is used to couple the two parts 12a, 12b of the product or device cover 12 together.

The low mass actuator 14 may be a linear actuator that is known in the art. The scope of the invention is not intended to be limited to the type or kind of low mass actuator 14. Moreover, embodiments are also envisioned in which other types of actuators now known or later developed in the future may be used within the spirit of the invention, including piezoelectric and magnetostrictive based actuators.

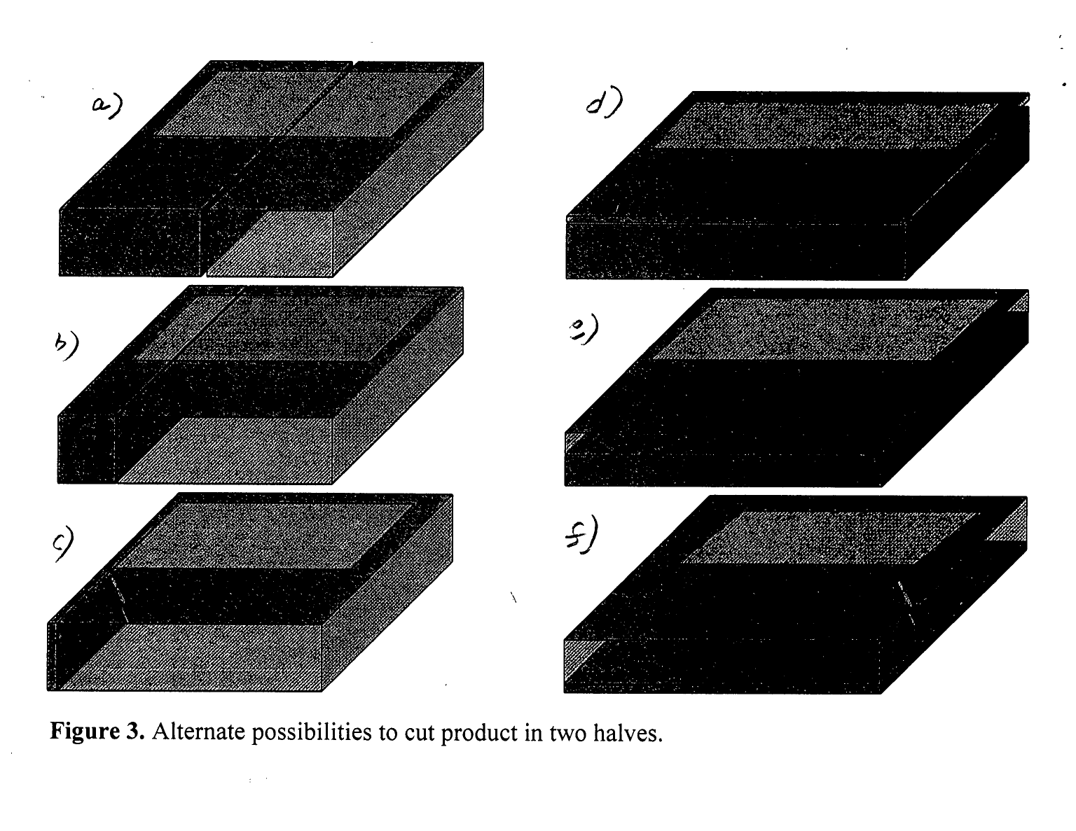

FIGS. 3(a) to (f) show alternative ways to separate the product cover into two pieces. The scope of the invention is not intended to be limited to the specific manner in which the product cover is separated, or the number of pieces into which it is separated. Embodiments are envisioned wherein the product cover is cut or separated in many different types of ways, as shown, or many different types of pieces. In other words, the product cover 12 may be cut in more than two parts if needed, as well as in different directions (vertical, horizontal diagonal, etc.), as best shown in FIGS. 3(a) to (f), whatever best suits the mechanical design of a specific product.

The arrangement 10 also includes a battery for powering the low mass actuator 14, as well as other components of the overall arrangement.

In operation, the linear actuator motor 14 or its variant is used to produce mechanical vibration in the direction shown by the arrow labelled B in FIG. 2. The actuator 14 is mounted in a way, where opposite ends are joined with the two parts 12a, 12b of the product cover 12. As the actuator 14 operates, it pushes and/or pulls two parts of the product cover in opposite directions, as shown.

These parts of the product cover are separated in (at least) two parts with the elastic joint 16 coupling the same together. This elastic joint 16 allows a very small variation of distance between the two parts 12a, 12b of the product cover 12 so that relative vibration of two parts 12a, 12b is possible while the actuator 14 operates. As the user (not shown) holds the product 12, the directly cover-coupled vibration is effectively felt by the user who experiences the haptic sensation.

The elastic joint 16 can be made with an adhesive layer, a two-shot injection molded assembly, or any other suitable or known method. The scope of the invention is not intended to be limited to any particular implementation of the elastic joint 16.

The present invention also aims to provide a unique technique of creating a mechanical vibration in a small product that cannot otherwise tolerate the volume of current vibration motors, especially since with present day technology, a straightforward method of a further size reduction of spinning mass does not appear possible, as it would result in too low vibration to be applicable.

The essential nature of the proposed invention is that small product volume variations are used to create vibration by using parts of the product cover as mechanically acting parts. Volume variation is produced by expanding and shrinking the device diameter as described. It should be understood that very low vibration amplitude is adequate (in covers) to produce user experience, especially if the small device is carried close to the skin (pendulum, jewelry-type products). Traditionally, more amplitude is needed as the whole phone mass is acting and vibration is produced deep inside the product.

However, one cannot directly compare the present invention with known vibration motors because the required force and amplitude of vibration are in totally different ranges—for example, compare a spinning mass with a diameter of 3-4 millimeters (mm) to the actuator distance required for the present invention which includes a movement amplitude in a range of about 5-15 ^{μ}m. It is not easy to compare durability or efficiency between the known technique and the present invention since they are not necessarily commensurate. For example, in some cases the 5-15 ^{μ}m movement of the present invention may not even be considered as a “free movement”.

Practical experiment of skin sensitivity can be made by slightly touching piano covers while somebody is playing or by touching a speaker membrane while music is played in a low volume. In the both cases, the minimally small vibration amplitudes are easily detectable. Use of minimal amplitude reduces requirements for durability and efficiency.

Human skin is the most sensitive at 250 Hz and can detect vibration with an amplitude of 1-20 ^{μ}m (Pacinian corpuscle cells in skin tissue).

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. An arrangement for creating a user detected vibration with a low mass actuator, comprising:
a product cover having two parts coupled by an elastic joint; and
a low mass actuator coupled between the two parts, responsive to an actuation signal, for vibrating the two parts of the product cover in relation to one another.

2. An arrangement according to claim 1, wherein the elastic joint is made from an adhesive layer.

3. An arrangement according to claim 1, wherein the low mass actuator is a linear actuator.

4. An arrangement according to claim 1, wherein the arrangement is a mobile phone.

5. An arrangement according to claim 1, wherein the actuation motor moves the two parts of the product cover a distance in a range of about 5-15 microns.

6. An arrangement according to claim 1, wherein the arrangement further comprises a battery for powering the actuation motor.

7. An arrangement according to claim 1, wherein the arrangement is a small product, including a wrist phone, amulet/pendulum/pen-phones, or small standard phones or accessories.

8. A product comprising:
a product cover having two parts; and
an actuation motor coupled between the two parts, responsive to an actuation signal, for moving the two parts of the product cover in relation to one another.

9. A product according to claim 8, wherein the two parts of the product cover are coupled by an elastic joint.

10. A product according to claim 9, wherein the elastic joint is made from an adhesive layer.

11. A product according to claim 8, wherein the actuation motor is a linear actuator.

12. A product according to claim 8, wherein the product is a mobile phone.

13. A product according to claim 8, wherein the actuation motor moves the two parts of the product cover a distance in a range of about 5-15 microns.

14. A product according to claim 8, wherein the product further comprises a battery for powering the actuation motor.
